(19) United States
(12) Patent Application Publication
(10) Pub. No.: US 2016/0325128 A1
(43) Pub. Date: Nov. 10, 2016

(54) AQUEOUS FILM-FORMING FOAM FIRE FIGHTING SYSTEM, METHOD AND APPARATUS

(71) Applicant: Black Peak Laboratory LLC, Dallas, TX (US)

(72) Inventor: David D. Booth, Brenham, TX (US)

(21) Appl. No.: 15/143,924

(22) Filed: May 2, 2016

Related U.S. Application Data
(60) Provisional application No. 62/157,520, filed on May 6, 2015.

(51) Int. Cl. A62C 5/02; A62C 3/06; F16L 37/02; A62C 35/02

(52) U.S. Cl. CPC A62C 5/02; A62C 35/026; A62C 3/06; F16L 37/02

(57) ABSTRACT

Apparatuses and methods are disclosed concerning an aqueous foam fire suppression system. The aqueous foam can be contained within a container that allows longer term, low maintenance storage of the aqueous foam. The container can be pierced with a piercing rod and the aqueous foam extracted from the container from the opening created by the piercing rod. The piercing rod can optionally include orifice(s) and internal channels to enable extraction of the aqueous foam without withdrawing the piercing rod.

### CROSS REFERENCE TO RELATED APPLICATIONS

This application claims the benefit of U.S. Provisional Application No. 62/157,520 filed May 6, 2015, which is hereby incorporated herewith.

### BACKGROUND

The present disclosure relates to method and apparatuses for distributing aqueous foam for use in suppressing fires.

The extraction of petroleum from the ground is a dangerous and risky proposition, but also required for providing fuel for transportation and heating of homes, material for the creation of composites, and the production of lubricants. The demand for petroleum products has led to a boom in the extraction of oil from various locations around the earth, including from the sea floor through the use of sea based oil platforms. Oil platforms provide an especially dangerous working environment for operators wherein the dangers of oceanic weather fronts, control of heavy machinery, and the extraction and storage of vast amounts of flammable material are combined. It is little wonder that oil platform workers are routinely ranked as one of the most dangerous jobs in the world.

A fire on an oil rig can be especially dangerous and disastrous, leading to potential loss of life, damage to the environment, and/or costly damage to equipment. Specialized products and procedures have therefore been developed to avoid and combat such fires. One such development is the use of aqueous foam, and especially aqueous film-forming foam, to combat petroleum fires. Aqueous foams advantageously coat petroleum, preventing the fire from having access to oxygen and smothering the fire as opposed to water which would simply disperse the flaming petroleum.

Despite these advances, hundreds of fires occur on oil rigs each year, including the Deepwater Horizon catastrophe of 2010. Additionally, current aqueous foam fire suppression systems have several limitations. Concentrated aqueous foam is transported to oil rigs and stored using a sealed storage container. Generally, current aqueous foam fire suppression systems use an intermediary storage tank. The concentrated aqueous foam must be transferred from the sealed storage container to the intermediary storage tank. However, the intermediary storage tank is generally not as well sealed as the storage container and exposes the aqueous foam contained within to atmospheric effects such as moisture. This can lead to degradation in the ability of aqueous foam stored in the intermediary tank to be useful for suppressing fires. The government mandates the periodic inspection of aqueous foam stored in the intermediary tank to ensure the viability of the concentrated aqueous foam over time. These inspections are costly and time consuming.

In order to avoid these inspections, an alternate approach has been developed to transfer concentrated aqueous foam from the storage container wherein the storage container is only opened at the time of use to combat a fire. This method has drawbacks in that the storage container is generally kept in a storage locker remote from the fire suppression system for several reasons. First, the storage container is susceptible to deterioration from ultraviolet radiation if left open to sunlight (such as on the deck of an oil rig). Additionally, most oil rigs have regulations avoiding loose containers and objects from being left in the open as they can become hazards. The remote location of the aqueous foam storage container also requires an excessive amount of time to relocate the storage container from the storage locker to the fire suppression system. It should be understood that time is a valuable commodity during an accident on an oil rig and can cost lives, environmental, and monetary damages.

Another time consuming drawback of currently operated aqueous foam fire suppression systems is the complicated control schema used to activate the system. Generally, at least three separate valves must be actuated to enable the system to be operable to generate fire suppressing aqueous foam. The separate actuation of these valves is time consuming and overly complicates the activation of the system.

Thus, there is a need for improvement in this field of aqueous foam fire suppression systems.

### SUMMARY

Further forms, objects, features, aspects, benefits, advantages, and embodiments of the present invention will become apparent from a detailed description and drawings provided herewith.

The disclosure concerns an aqueous foam fire suppression system, which can comprise a piercing rod configured and arranged to pierce the exterior of a container of aqueous foam, forming an orifice, a foam eductor member, an actuation member, and a suction member in fluid communication with the foam eductor. The actuation member can be coupled to the piercing rod. The suction member can be configured and arranged to draw aqueous foam from the container through the orifice created by the piercing rod. The foam eductor member can be configured and arranged to mix aqueous foam drawn from the container with a liquid flowing through the foam eductor member.

The piercing rod and the suction member can be mechanically coupled or a unitary combination to enable suction of the aqueous foam without the withdraw of the piercing rod from the container. The foam eductor member can be configured and arranged to draw aqueous foam from the container through the suction member substantially via fluid pressure effects from liquid flowing through the foam eductor member.

An aqueous foam fire suppression system of the type disclosed herein can further comprise a valve situated between the suction member and the foam eductor member wherein the valve is configured and arranged to enable opening and closing of the fluid communication path between the suction member and the foam eductor member by an operator. The system can further comprise a lever wherein the piercing rod is mechanically coupled to the lever and the lever is configured and arranged to enable piercing of the container through the actuation of the lever.

The system can be configured such that the force of the actuation of the lever substantially induces the force necessary for the piercing rod to pierce the container. The system can further comprise a UV protection member configured and arranged to protect the container from UV radiation prior to piercing of the container. The system can further comprise a three-way valve and an outlet port in fluid communication with the three-way valve and the foam eductor member. The three-way valve can be configured such that actuation of the valve to a first state diverts liquid substantially free of aqueous foam to the outlet port and the actuation of the valve to a second state diverts liquid containing aqueous foam to the outlet port. The actuation of the valve to the first configuration can be accomplished automatically after the container has been pierced by the piercing rod.

The system can further comprising a check valve configured and arranged to prevent liquid from flowing into the container. The system can further comprise a holding assembly configured and arranged to hold the container in a position in the path of the piercing rod for the piercing rod to pierce the container.

Also disclosed is a piercing rod configured and arranged to pierce the exterior of a container of aqueous foam and configured and arranged to enable the suction of aqueous foam from the container using the piercing rod without the withdraw of the piercing rod from the container. The piercing rod can further comprise a lever wherein the piercing rod can be mechanically coupled to the lever and the lever can be configured and arranged to enable piercing of the container through the actuation of the lever. The force of the actuation of the lever can substantially induce the force necessary for the piercing rod to pierce the container.

The piercing rod can further comprise an orifice near the piercing end of the piercing rod configured and arranged to draw aqueous foam. The piercing rod can further comprise a channel partially contained within the piercing rod and in fluid communication with the orifice and an outlet orifice configured and arranged such that when a vacuum is applied to the outlet orifice, aqueous fluid in contact with the piercing end of the piercing rod will be drawn through the channel.

Additionally disclosed is a method of operating a fire suppression system, comprising piercing the exterior of a container with a piercing rod such that the piercing rod contacts aqueous foam within the container and drawing the aqueous foam from the container through the orifice created by the piercing rod. The method can include piercing of the exterior of the container with the piercing rod and can be accomplished through the actuation of a lever mechanically coupled to the piercing rod.

The method can further comprise the step of introducing a container containing aqueous foam into the path of insertion of a piercing rod. The method can further comprise the step of combining the aqueous foam with a liquid. The method can further comprise the step of applying the liquid and aqueous foam mixture to a fire to suppress the fire.

Several non-limiting aspects of the invention are disclosed herein:

Aspect 1 concerns an aqueous foam fire suppression system, comprising:

a piercing rod configured and arranged to pierce the exterior of a shipping container of aqueous foam, forming an orifice;

an actuation member coupled to the piercing rod and wherein the actuation member is configured and arranged to move the piercing rod with sufficient force to pierce the container;

a foam eductor member;

a suction member in fluid communication with the foam eductor;

wherein the suction member is configured and arranged to draw aqueous foam from the container through the orifice created by the piercing rod; and

wherein the foam eductor member is configured and arranged to mix aqueous foam drawn from the container with a liquid flowing through the foam eductor member.

Aspect 2 concerns any previous aspect, wherein the piercing rod and the suction member are mechanically coupled or unitary to enable suction of the aqueous foam without withdraw of the piercing rod from the container.

Aspect 3 concerns any previous aspect, wherein the foam eductor member is configured and arranged to draw aqueous foam from the container through the suction member substantially via fluid pressure effects from liquid flowing through the foam eductor member.

Aspect 4 concerns any previous aspect, further comprising a valve situated between the suction member and the foam eductor member wherein the valve is configured and arranged to enable opening and closing of the fluid communication path between the suction member and the foam eductor member by an operator.

Aspect 5 concerns any previous aspect, wherein the actuation member comprises a lever wherein the piercing rod is mechanically coupled to the lever and the lever is configured and arranged to enable piercing of the container through the actuation of the lever.

Aspect 6 concerns any previous aspect, wherein the force of the actuation of the lever substantially induces the force necessary for the piercing rod to pierce the container.

Aspect 7 concerns any previous aspect, further comprising a UV protection member configured and arranged to protect the container from UV radiation prior to piercing of the container.

Aspect 8 concerns any previous aspect, further comprising:

a three way valve;

an outlet port in fluid communication with the three way valve and the foam eductor member;

wherein the three way valve is configured such that actuation of the valve to a first state diverts liquid substantially free of aqueous foam to the outlet port and the actuation of the valve to a second state diverts liquid containing aqueous foam to the outlet port;

and wherein the three way valve is actuated to the second state automatically in conjunction with the movement of the piercing rod.

Aspect 9 concerns any previous aspect, further comprising a check valve configured and arranged to prevent liquid from flowing into the container.

Aspect 10 concerns any previous aspect, further comprising a holding assembly configured and arranged to hold the container in a position in the path of the piercing rod for the piercing rod to pierce the container.

Aspect 11 concerns any previous aspect, comprising:

a piercing rod configured and arranged to pierce the exterior of a shipping container of aqueous foam and configured and arranged to enable the suction of aqueous foam from the container using the piercing rod without withdraw of the piercing rod from the container; and

an actuation member that is manually actuated to move the piercing rod with sufficient force to pierce the exterior of the container.

Aspect 12 concerns any previous aspect, wherein the actuation member comprises a lever.

Aspect 13 concerns any previous aspect, wherein the force of the actuation of the lever substantially induces the force necessary for the piercing rod to pierce the container.

Aspect 14 concerns any previous aspect, further comprising an orifice near the piercing end of the piercing rod wherein the orifice is configured and arranged to draw aqueous foam.

Aspect 15 concerns any previous aspect, further comprising a channel at least partially contained within the piercing rod and in fluid communication with the orifice and an outlet orifice configured and arranged such that when a vacuum is applied to the outlet orifice, aqueous fluid in contact with the piercing end of the piercing rod will be drawn through the channel.

Aspect 16 concerns any previous aspect, comprising:
a) actuating an actuation member coupled to a piercing rod wherein the actuation of the actuation member moves the piercing rod with sufficient force to pierce a shipping container for aqueous foam;
b) piercing the exterior of a container with a piercing rod such that the piercing rod contacts aqueous foam contained within the container; and
c) drawing the aqueous foam from the container through the orifice created by the piercing rod.

Aspect 17 concerns any previous aspect, wherein the actuation member comprises a lever mechanically coupled to the piercing rod.

Aspect 18 concerns any previous aspect, further comprising the step of introducing a container containing aqueous foam into the path of insertion of a piercing rod.

Aspect 19 concerns any previous aspect, further comprising the step of combining the aqueous foam with a liquid.

Aspect 20 concerns any previous aspect, further comprising the step of applying the liquid and aqueous foam mixture to a fire to suppress the fire.

Aspect 21 concerns any previous aspect, wherein the piercing rod includes an apex offset from the longitudinal axis of the piercing rod.

Aspect 22 concerns any previous aspect, wherein the piercing rod includes a threaded coupling member.

Aspect 23 concerns any previous aspect, wherein the piercing rod body when positioned within the opening created by the piercing of the exterior wall 302 of a container, allows air to flow around the piercing rod body.

Aspect 24 concerns any previous aspect, wherein the piercing rod body includes a dedicated channel or indentation to allow atmosphere to flow past the piercing rod body is positioned within the opening created by the piercing of the exterior wall 302 of a container

Aspect 25 concerns any previous aspect, wherein the piercing end of the piercing rod includes a projection that increases a cross sectional length of the piercing end to be greater than a corresponding cross sectional length of the piercing rod body when viewed along the longitudinal axis of the piercing rod.

Aspect 26 concerns any previous aspect, wherein cross sectional shape of the piercing rod when viewed along the longitudinal axis from the piercing end is elliptical.

Aspect 27 concerns any previous aspect, wherein cross sectional shape of the piercing rod when viewed along the longitudinal axis from the piercing end is star shaped.

Aspect 28 concerns any previous aspect, wherein cross sectional shape of the piercing rod when viewed along the longitudinal axis from the piercing end is wedge shaped.

Aspect 29 concerns any previous aspect, wherein the device includes a safety member that prevents the actuation of the piercing rod until the safety member is disabled or moved.

Aspect 30 concerns any previous aspect, wherein the safety member mechanically prevents the actuation of the lever.

Aspect 31 concerns any previous aspect, wherein the safety member is a pin.

Aspect 32 concerns any previous aspect, wherein length of the lever is between one half and three meters.

Aspect 33 concerns any previous aspect, wherein the piercing rod is mounted to the lever between one fourth and three meters from the rotatable coupling of the lever.

Aspect 34 concerns any previous aspect, wherein an orifice of the piercing rod includes a screen member.

Aspect 35 concerns any previous aspect, wherein the screen member is monolithically integrated into the piercing rod.

Aspect 36 concerns any previous aspect, wherein the piercing rod comprises multiple apexes on the piercing end.

Aspect 37 concerns any previous aspect, wherein the piercing rod comprises an annular apex on the piercing end.

Aspect 38 concerns any previous aspect, wherein the piercing rod comprises a substantially linear edge apex on the piercing end.

Aspect 39 concerns any previous aspect, wherein the system includes a handle substantially perpendicular to the lever.

Aspect 40 concerns any previous aspect, wherein the system includes a handle that is offset from the lever.

Aspect 41 concerns any previous aspect, wherein the system includes a handle with an elastomeric coating.

Aspect 42 concerns any previous aspect, wherein the handle is coupled to the lever.

Aspect 43 concerns any previous aspect, wherein a portion of the system is painted the color red.

Aspect 44 concerns any previous aspect, wherein aqueous foam is drawn from the container by creating a low pressure area.

Aspect 45 concerns any previous aspect, wherein a venturi effect is used to draw aqueous foam from the container.

Aspect 46 concerns any previous aspect, wherein the system includes a check valve configured and arranged to prevent aqueous foam solution from mixing with liquid when the system is configured to selectively output aqueous foam solution or liquid without aqueous foam.

Aspect 47 concerns any previous aspect, wherein the three way valve is actuated to the first state automatically in conjunction with the movement of the piercing rod.

### BRIEF DESCRIPTION OF THE DRAWINGS

FIG. 1 is a fragmented front elevational view of an aqueous solution fire suppression device.

FIG. 2 illustrates a side elevational view of the device of FIG. 1.

FIGS. 3-6 illustrate various features of piercing rods for use with the device of FIG. 1.

FIG. 7 is a diagrammatic view of the front view illustration of FIG. 1 to illustrate several dimensions of the device.

FIG. 8 illustrates a fire suppression system using the device of FIG. 1.

FIG. 9 illustrates a feature of a piercing rod for use with the device of FIG. 1.

FIGS. 10-12 illustrate views of the piercing ends of piercing rods for use with the device of FIG. 1.

FIG. 13 illustrates features of the piercing end of piercing rods for use with the device of FIG. 1.

FIG. 14 illustrates a cross sectional view of a foam eductor for use with the system of FIG. 8.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

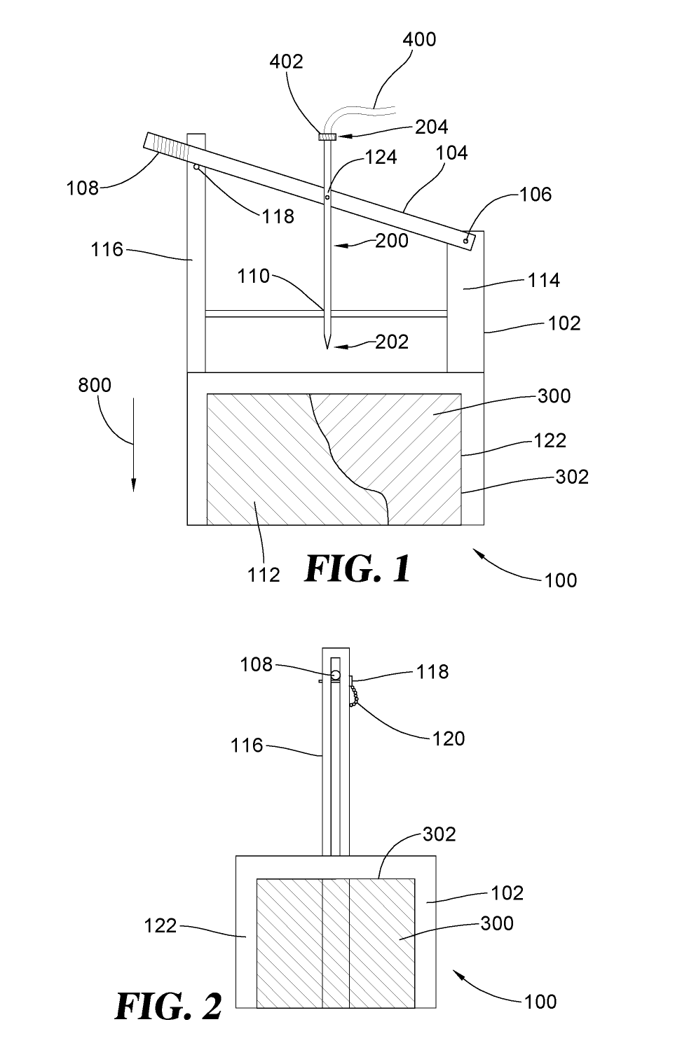

FIG. 1 illustrates an aqueous foam fire suppression device 100 configured for extracting aqueous foam from a container 300 using a piercing rod 200. In the exemplary embodiment, container 300 is a storage container for storing aqueous foam and can take the form of a five gallon polymer bucket, for example. Such storage containers are generally rated to have a shelf storage life span that mitigates maintenance inspection schedules associated with conventional fire suppression devices that distribute aqueous foam. Additionally, the direct extraction of the aqueous foam from a storage container increases the probability that the aqueous foam is still viable as a fire suppressing agent as aqueous foam stored in a non-sealed transportation container can degrade due to weathering effects, interaction with the atmosphere, and general interaction with contaminants.

The piercing rod 200 includes a piercing end 202 and a coupling end 204. The piercing end 202 is illustrated as the end configured to pierce the exterior wall 302 of the container 300. The coupling end 204 is configured to enable coupling of the piercing rod to fluid transportation member 400, illustrated as a hose. The fluid transportation member 400 can include a complementary coupling member 402 as part of the coupling end 204 of the piercing rod 200 and, when provided coupling member 402 is used to form a liquid tight seal between the piercing rod 200 and the fluid transportation member 400. Other forms of establishing a liquid tight seal are contemplated including, but not limited to, a slip ring or a compression fitting.

The device 100 includes a frame 102 that can be made of metal. Advantageously, the frame 102 can be substantially composed of stainless steel or other metals that resist corrosion. The frame can also be coated with a corrosion preventive coating and ideally colored to signify the fire fighting properties of the device 100 (such as red). Alternatively, or in combination, the device 100 (including the piercing rod 200) can be manufactured from composites to decrease weight and decrease the device's 100 susceptibility to corrosion. In the exemplary embodiment, device 100 includes a shorter frame rail 114 and a longer frame rail 116 to support a lever 104. The piercing rod 200 can be coupled to the lever 104 through the use of a mounting 124. The device 100 can additionally include a guide member 110. The guide member 110 as illustrated includes an opening having a dimension larger than the cross-section dimension of the body 201 of the piercing rod 200. The guide member constricts the piercing rod to move in a direction towards the container 300 when the lever 104 is actuated. The combination of the piercing rod 200 with lever 104 and guide member 110 is used to cause the piercing rod 200 to pierce an exterior wall 302 of the container 300 as will be described herein. The device 100 additionally includes a holding assembly 122 for the storage of the container 300. The holding assembly 122 can be configured and arranged to securely store the container 300 within the holding assembly 122 to facilitate piercing of the container 300 by the piercing rod 200.

The lever 104 includes a rotatable coupling 106 securing the hinged end of lever 104 to the short frame rail 114. When a user actuates the lever by moving the actuation end 108 of the lever 104 towards the container 300, the piercing rod 200 is concurrently moved towards the container 300. Depending on the length of the lever arm 104 and the distance between the rotatable coupling 106 and the mounting 124, the amount of force imparted to the piercing rod 200 as well as the length of travel of the piercing rod 200 can be altered. The device 100 of the exemplary embodiment includes a safety pin 118 located on the long frame rail 116. The safety pin 118 can be used to prevent inadvertent release of lever 104 which could result in piercing of the container 300. The device 100 can be arranged such that the safety pin 118 must be removed in order to enable piercing of the container 300. Optionally, the device 100 can also include an ultraviolet (UV) cover 112 configured to prevent UV radiation from compromising the container 300 over time due to weathering effects from the sun, as can occur when a container is left on the deck of an oil rig.

It is contemplated that the ability of the device 100 to pierce the container 300 can be improved if a twisting motion is simultaneously imparted into the piercing rod 200 as the piercing rod impacts the exterior wall 302 of the container 300. The twisting motion can be imparted from the pulling of the lever 104 or through a separate actuator. This twisting motion can be used in conjunction with a spiral or helical piercing rod 200 or a piercing rod 200 with annular apex(es) 206 or apexes 206 arranged in an annular formation in order to improve the ability of the piercing rod 200 to penetrate the exterior wall 302 of a container 300. The twisting motion can be imparted, for example, through the use of a screw drive that can be actuated via a electromechanically or hydraulic means.

Although the piercing rod 200 is illustrated as being located above the container 300, it should be understood that other piercing rod locations are contemplated for use with the device 100. As used herein, the term “above” references the direction opposite to arrow 800 indicated in FIG. 1. The terms below and downward reference the direction or side of the container indicated as arrow 800. The piercing rod 200 can be located to the side of the container 300 for side piercing, or can be located below the container 300 for piercing the container 300 from below. Additionally, the piercing rod 200 can contact the container 300 from various angles. For example, the device 100 can be configured such that the piercing rod 200 pierces the container 300 through the side of the container at a downward angle. Such an angle may position the piercing end 202 of the piercing rod 200 to contact the interior bottom of the container 300 and enable more aqueous foam to be extracted from the container 300. The bottom of the container 300 is where aqueous foam contained within the container will settle due to gravitational forces, more so as the aqueous foam is extracted from the container 300. An angled orientation between the piercing rod 200 and the container 300 may also help prevent blockages between the piercing rod 200 and, for example, remnants of the container's 300 exterior walls 302 after piercing. The angle may also ease the piercing of the exterior wall 302 of the container 300 by orienting the piercing rod 200 such that more pressure is applied to the exterior wall 302 of the container 300 by the piercing end 202 of the piercing rod 200.

The generation of the force used to pierce the container 300 is contemplated as being provided by several alternative sources or from a combination of sources. The lever 104 is illustrated as being operable by a person to actuate the piercing rod 200. However, other actuation members/means are contemplated including hydraulic, electromechanical, or other. Human actuation has the benefits of allowing the device to be relatively uncomplicated and relatively more reliable than using other actuation means. However, the powered (hydraulic and electromechanical) means may be beneficial in order to reduce user fatigue, or to enable the device 100 to be miniaturized. The miniaturization may be beneficial if limited space is available for positioning of the device 100 such as on an oil rig, for example. Electromechanical actuation can be used to enable remote actuation of the piercing rod 200 and subsequent distribution of aqueous foam.

FIG. 2 illustrates a side view of the device 100 illustrated in FIG. 1. The side view further illustrates the orientation of the container 300 within the device 100. Illustrated is one example configuration of the actuation end 108 of the lever, as well as the safety pin 118 and a chain 120 configured to couple the safety pin 118 to the frame 102 in order to prevent loss of the safety pin 118 when it is removed. The actuation end 108 is illustrated as being substantially collinear and parallel with the lever 104. It is contemplated that the actuation end 108 can alternatively be perpendicular to the lever 104 in order to change the location of the portion of the lever 108 that a user would grip or the orientation of the user when the user is actuating the lever 104 to pierce the container 300 using the device 100. Still other orientations and configurations of the lever 104 and the actuation end 108 are contemplated. For example, the actuation end 108 can be parallel, perpendicular, or at an angle to the lever 104. The actuation end 108 can be located above, below, or to the sides of the lever 104. The actuation end 108 can be adjustable to several different positions through the use of, for example, fasteners. The various configurations can be altered depending on the environment that the device 100 is used in. For example, an oil platform may have limited space in certain dimensions and may require the operator to be positioned differently relative to the device 100 as compared to other implementation of the device within other oil rigs or in different locations of the same oil rig.

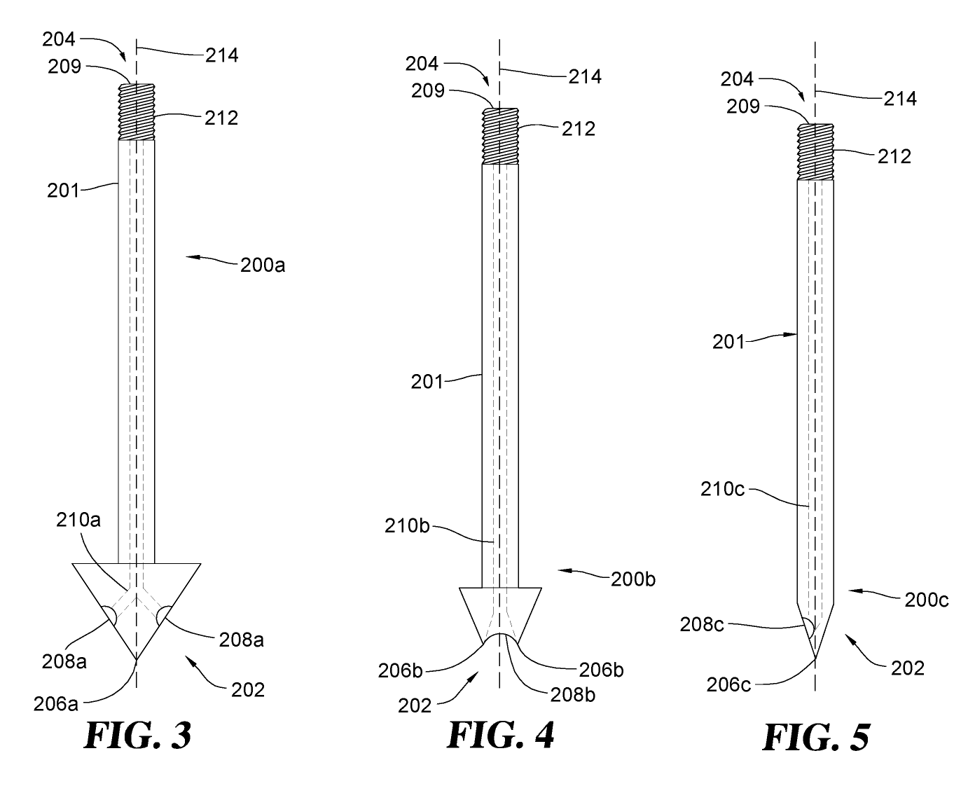

FIGS. 3-6 illustrate example piercing rods 200a-d. The piercing rods 200a-d include a piercing end 202 and a coupling end 204. The piercing rods can include one or more apexes 206a-d on the piercing end 206. The apex(es) 206a-d can be configured and arranged to increase the amount of pressure that is applied to a container 300 when the piercing rod is used to penetrate the exterior wall 302 of the container 300 by decreasing the surface area of the piercing rod contacting the container 300. The piercing end 202 can also include one or more input orifice(s) 208a-d. The piercing rod can also define one or more channels 210a-d in fluid communication with input orifice(s) 208a-d and output orifice 209. The input orifice(s) 208a-d can be configured to enable extraction of aqueous foam from the container 300 after the piercing rod 200 has penetrated the exterior wall 302 of the container 300. The aqueous foam can then be drawn through the piercing rod 200 and out the output orifice 209 of the coupling end 204 of the piercing rod 200 via the channels 210a-d. The coupling end 204 can optionally include threads 212 to enable coupling to a fluid transportation member 400 (such as hoses with complementary threaded coupling members).

FIGS. 3-6 illustrate various non-limiting features of the invention. FIGS. 3-6 are provided to illustrate example features that can be combined in several differing combinations not specifically illustrated. FIG. 3 illustrates a piercing end 202 with a relatively large cross sectional area as compared to the body 201 of the piercing rod 200a. Such a configuration can create a relatively large hole in the exterior wall 302 of a container 300 pierced by the piercing rod 200a. The hole created in the container can be larger than the body 201 of the piercing rod, allowing air to enter the container 300 around the body 201 after the container 300 has been pierced. This may be advantageous if the aqueous foam is extracted by an extraction member (not illustrated) distinct and separate from the piercing rod 200. Depending on the composition of the container 300, the relatively large piercing end 202 may also aid in the extraction of the piercing rod 200 from the container 300. Additionally, the opening created by the piercing rod can allow atmosphere to enter the container 300 during the aqueous foam extraction, balancing the pressure within the container 300 to atmospheric norms. The opening to the atmosphere can prevent the amount of vacuum force needed to extract aqueous foam from the container 300 during the extraction process.

FIG. 4 illustrates a piercing rod 200b wherein the apex 206a of FIG. 3 is replaced by an orifice 208b. Such a configuration can form an annular apex 206b or multiple apexes 206b, depending on the cross sectional shape of the piercing rod 200b. This configuration can advantageously enable extraction of foam from the bottom of container 300 when the container 300 is pierced from above, thus extracting more foam per container 300. Additionally, multiple apexes 206 can aid in piercing of the container 300. Still another advantage of this configuration can be ease of manufacture wherein a singular channel 210b can be drilled axially through the piercing rod 200b along the longitudinal axis 214.

FIG. 5 illustrates a piercing rod 200c with a piercing end 202 having a cross section diameter no greater than the body 201. The orifice(s) 208c can be located on the side of the piercing rod 200c. This configuration can advantageously aid in the extraction of the piercing rod 200c from the container if the container 300 is made from certain materials, plastics for example. It should be noted that the orifice(s) 208c can be located at various locations, such as the locations illustrated in FIG. 3 and/or FIG. 4.

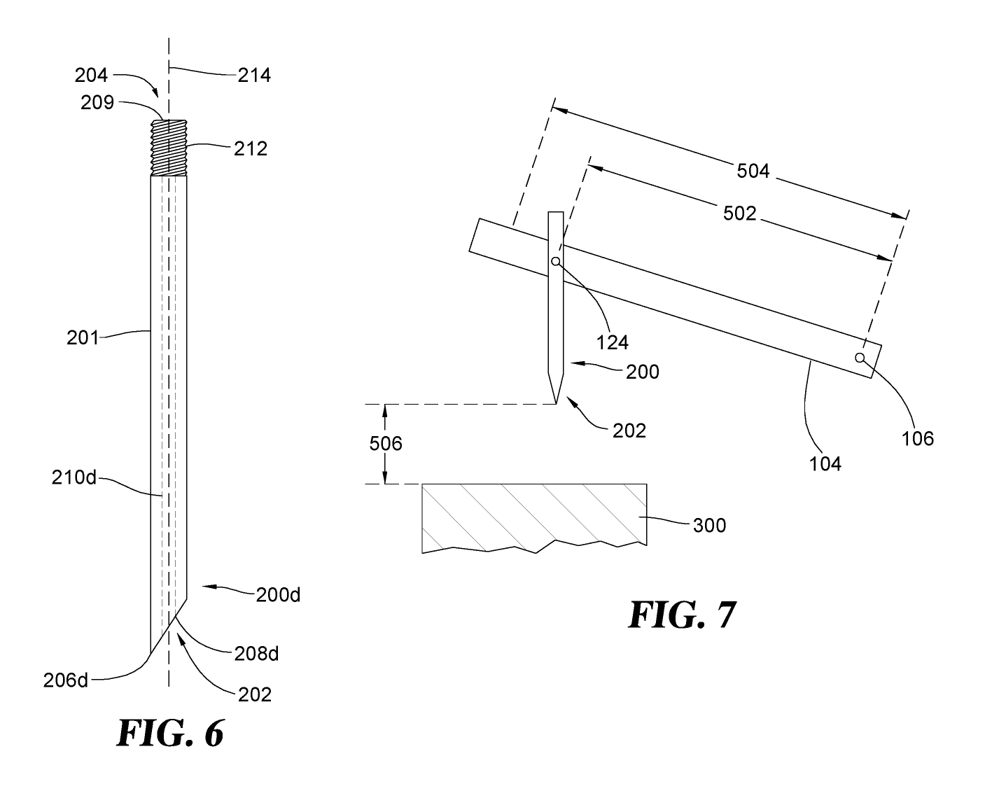

FIG. 6 illustrates a piercing rod 200d wherein there is a singular apex 206d offset from the axial center of the piercing rod 200d. The channel 210d is illustrates as substantially being incident with the central longitudinal axis 214 of the piercing rod 200d. The apex 206d can be located distally from the orifice 208d when referenced to the coupling end 204. This configuration advantageously simplifies the manufacture of the piercing rod 200d. As an example manufacturing process, a hollow, cylindrical pipe can be intersected by a saw at an angle to the central longitudinal axis, substantially forming the illustrated configuration. Beneficially, the singular apex 206d can increase the pressure applied to the container 300 when the piercing rod 200d is used to pierce the exterior wall 302 of the container. The configuration of the piercing end 202 of the piercing rod 200d illustrated can also prevent the exterior wall 302 of the container 300 from blocking the orifice 208d.

FIGS. 3-6 all illustrate side views of piercing rods. The body 201 of the rod, when viewed along the central longitudinal axis 214, can have a cross sectional shape of a circle, ellipse, square, triangle, or other polygon. The cross sectional shape can also be organic. Similarly, the cross section shape of the piercing end 202 when viewed along the central longitudinal axis can be circular, elliptical, organic, or polygonal. The piercing end 202 can also be substantially planar or can consist of a “star” pattern of several intersecting planes.

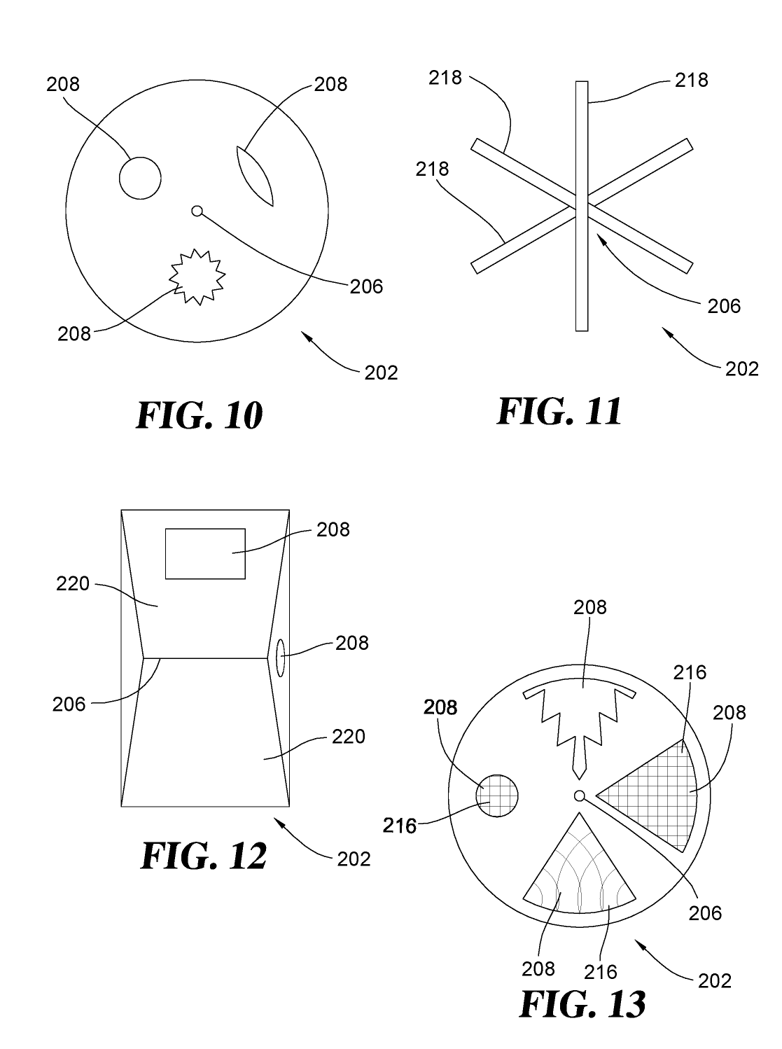

FIGS. 10-12 illustrate several example cross section shapes of the piercing rod 200 when viewed towards the piercing end 202 along the longitudinal axis 214. The shape illustrated in FIG. 10 is circular. A circular shape has benefits related to possible ease of manufacture as well as possibly reducing destructive forces that may be imparted to the piercing rod 200 from piercing the container 300. Additionally, the circular shape provides ample surface area for locating one or more orifices 208 of one or more shapes. FIG. 11 alternatively illustrates a star shaped pattern formed by several intersection planes 218. The star shaped can be advantageous for piercing containers 300 made of various materials. The star shape can reduce the surface area of the piercing end 202 that contacts the container 300, increasing the amount of pressure applied to the container 300 as the piercing rod 200 pierces the container 300. Any number of planes can be used with the star pattern illustrated, including a singular plane 218 to form an “arrowhead” piercing arrangement. FIG. 12 illustrates an arrangement wherein the apex forms a linear “knife edge” along the piercing end 202 of the piercing rod 200. Orifices 208 can be located at various locations around the apex 206, as illustrated. This configuration may be beneficial for a metal skinned container 300 in order to “peal” the metal away and form an orifice. This configuration can also help prevent foreign objects from the piercing of the container 300 from impacting the orifice 208, especially if the orifice is not located on the inclined sides 220 of the piercing end 202.

The orifice(s) 208 can optionally have screen member(s) 216 illustrated in FIG. 13 overlaid into the piercing rod 200 or manufactured monolithically into the piercing rod 200. Such screen members 216 can be configured and arranged to prevent foreign objects from entering the orifice(s) 208 and subsequently the rest of the foam delivery system. Foreign objects can include remnants from the exterior wall 302 of the container 300 after it is pierced or other solid objects within the container 300. The screen element(s) can take the form of a grid or other patterned screen or protrusions monolithically integrated with the piercing rod 200. The screen element(s) 216 advantageously limit the size of object that can enter the orifice(s) 208 while still allowing sufficient aqueous foam to be drawn from the container 300 by ostensibly increasing the number of orifices through which foam can be drawn.

The piercing rods 200 illustrated can be manufactured from a monolithic piece of material, or can be formed from separate elements. For example, the piercing rod 200d of FIG. 6 can be manufactured from a monolithic piece of hollow pipe. Alternatively, the piercing rod 200 can include separate piercing ends 202 or coupling ends 204 coupled to the body portion 201. The piercing rod 200 can also include internal piping, tubing, or hosing to form the various channels 210 contained within the body portion 201.

FIG. 7 illustrates several dimensions useful for characterizing the combination of the piercing rod 200 with the lever 104. Dimension 502 illustrates a distance between rotatable coupling 106 and mounting 124. As distance 502 is increased, the range of motion 506 between the piercing rod 200 and the container 300 is increased. A distance 502 of between one fourth meter and three meters can be advantageous to provide sufficient range of motion 506 to accommodate most aqueous foam storage containers 300.

The distance 504 between the rotatable coupling 106 and the actuation end 108 of the lever is illustrated. Increasing the distance 504 can increase the moment arm created by the actuation of the lever 104. Increasing the moment arm can increase the amount of pressure imparted by the piercing rod 200 to the exterior wall 302 of the container 300 while decreasing the force required to be imparted by a user or other actuation means (optimizing the amount of force vs the amount of travel required to create a target pressure upon the container 300). A distance of between one half and three meters can enable the impartation of sufficient pressure to pierce the exterior wall 302 of a container 300 without unduly burdening a user.

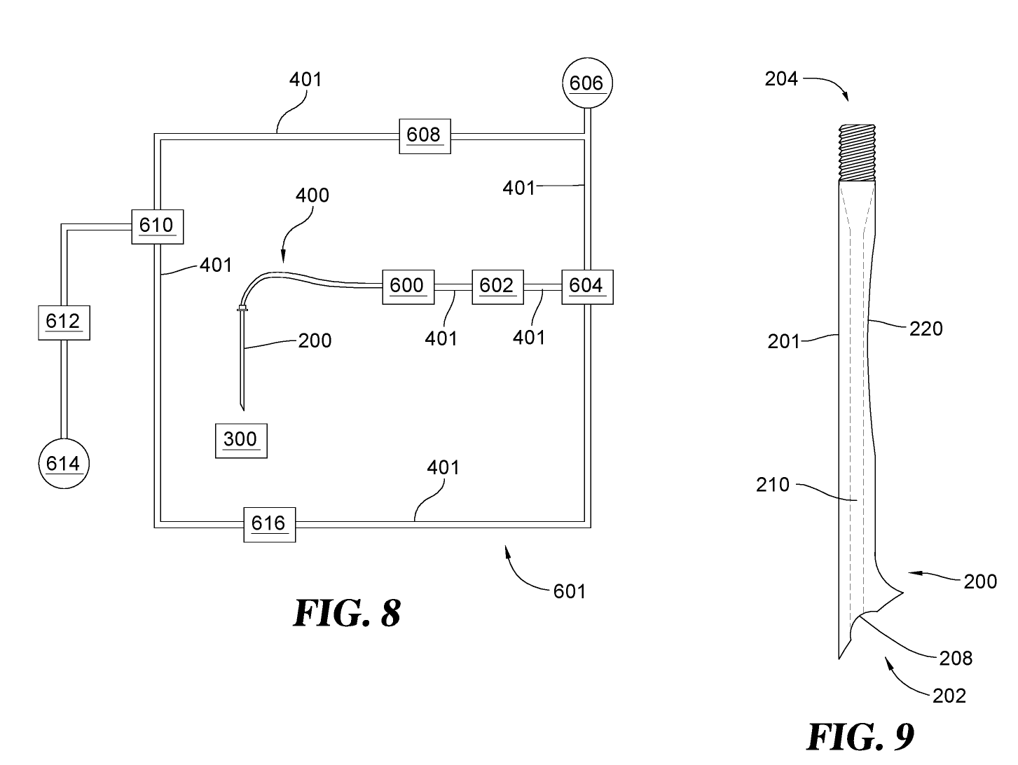

FIG. 8 illustrates a system 601 for use with the piercing rod 200. The system includes the piercing rod 200 with the fluid transportation member 400 (illustrated as a flexible hose). The system 601 can include several other fluid transportation members 401 to enable fluid coupling between the various components of the system 601. The fluid transportation members 400 or 401 can take the form of pipes, hoses, tubing, or other such members. The system includes a normally open ball valve 600 and a check valve 602. As used herein, a check valve is a one way valve that allows fluid to flow in substantially only one direction. As illustrated, the check valve can allow foam to be extracted from the piercing rod 200 while preventing fluid from back flowing through the piercing rod and into the container 300. The system includes a foam eductor 604. A foam eductor is a device used for mixing foam with liquid (such as water). The foam eductor 604 is configured and arranged such that foam is drawn into the foam eductor 604 via fluid forces imparted by the flow of liquid through the foam eductor 604. For example, a venturi effect can be used to create a low pressure area within the foam eductor 604 as compared to atmospheric pressure.

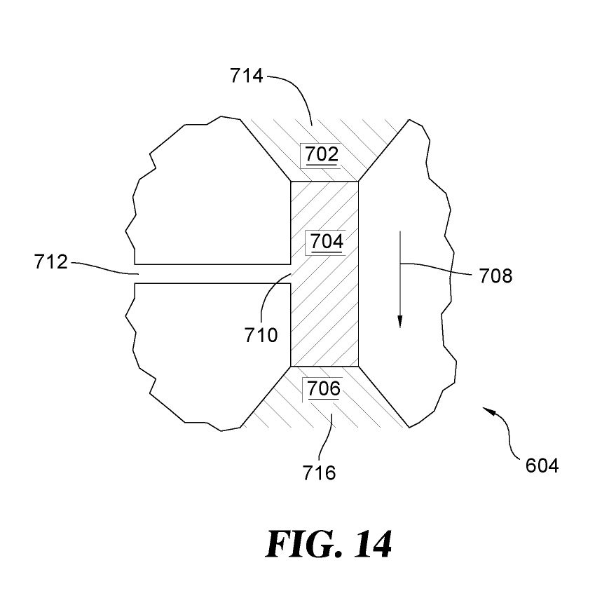

FIG. 14 illustrates a cutaway view of a portion of an example foam eductor 604. The illustrated mechanism includes an input opening 714 and an output opening 716 for a fluid to flow in the direction indicated by arrow 708. It should be noted that the foam eductor 604 will operate similarly if the fluid flows in a direction opposite to arrow 708. The fluid (such as water) enters through the input opening 714, through the contraction region 702, through the low pressure region 704, and through the expansion region 706. The shape of the regions 702, 704, and 706 cause the fluid to flow at higher velocity within the low pressure regions 704 as compared to the contraction region 702 and expansion region 706. The increase in velocity of the fluid results in a corresponding decrease in pressure as compared to atmospheric pressure. An opening 712 is provided for the addition of aqueous foam via opening 710. The opening 710 is in contact with the low pressure region 704, causing aqueous foam to be drawn into the low pressure region 704 via a venturi effect if the aqueous foam is subjected to atmospheric pressure.

Referring now to FIG. 8, the system 601 includes an outlet port 606 configured and arranged to allow water and/or a water/foam mixture to leave the system 601. The system also includes an inlet port 614 configured and arranged to allow pressurized water to enter the system 601. Devices 612, 610, 616, and 608 can optionally be included and can enable the selection of water or a water/foam mixture to be extruded from the outlet port 606. Check valve 608 can be used to prevent water/foam mixture from foam eductor 604 from entering the water only portion of the system. Three-way valve 610 can be used to select the system from extruding water only or a water/foam mixture by diverting water from the inlet port 614 to the outlet port 606 via the check valve 608 or to the foam eductor 604 via valve 616. Valves 600, 616, and 612 can be used to prevent water and/or foam from flowing through the system 601 as backups in case of system fault, for system maintenance, for system testing, or for other reasons. The three-way valve 610 can be mechanically coupled to the lever 104 such that when the lever 104 is used to move the piercing rod 200 to pierce the container 300, the three-way valve 610 automatically diverts water the water/foam mixture to the outlet port 606. Additionally, the movement of the piercing rod 200 away from the container 300 can be used to automatically divert water without foam mixture to the outlet port 606 via the three-way valve 610. The other valves 600, 616, and 612 can alternatively or additionally be coupled to the lever to enable the automatic dispersal of aqueous foam mixture after the container 300 is pierced by the piercing rod 200.

FIG. 9 illustrates a feature that can be used in combination with the example piercing rods 200a-d illustrated in FIG. 3-6. Illustrated is an atmospheric indentation 220 separate and distinct from the foam channel 210. The atmospheric indentation 220 can optionally take the form of a channel coupled between two or more orifices, one of which is positioned within the container when the piercing rod 200 is positioned to extract aqueous foam from the container 300. Another orifice can be positioned outside of the container 300 when the aqueous foam is being extracted. The indentation 220, as illustrated, can be used to create an opening along the side the body 201 of the piercing rod. The atmospheric indentation or channel 220 can provide a path for atmosphere to flow into the container when the aqueous foam is being extracted, preventing a vacuum from forming within the container 300 during the aqueous foam extraction process and bringing the pressure inside of the container to substantially match the standard atmospheric pressure.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. An aqueous foam fire suppression system, comprising:
a piercing rod configured and arranged to pierce the exterior of a shipping container of aqueous foam, forming an orifice;
an actuation member coupled to the piercing rod and wherein the actuation member is configured and arranged to move the piercing rod with sufficient force to pierce the container;
a foam eductor member;
a suction member in fluid communication with the foam eductor;
wherein the suction member is configured and arranged to draw aqueous foam from the container through the orifice created by the piercing rod; and
wherein the foam eductor member is configured and arranged to mix aqueous foam drawn from the container with a liquid flowing through the foam eductor member.

2. The system of claim 1, wherein the piercing rod and the suction member are mechanically coupled or unitary to enable suction of the aqueous foam without withdraw of the piercing rod from the container.

3. The system of claim 1, wherein the foam eductor member is configured and arranged to draw aqueous foam from the container through the suction member substantially via fluid pressure effects from liquid flowing through the foam eductor member.

4. The system of claim 1, further comprising a valve situated between the suction member and the foam eductor member wherein the valve is configured and arranged to enable opening and closing of the fluid communication path between the suction member and the foam eductor member by an operator.

5. The system of claim 1, wherein the actuation member comprises a lever wherein the piercing rod is mechanically coupled to the lever and the lever is configured and arranged to enable piercing of the container through the actuation of the lever.

6. The system of claim 5, wherein the force of the actuation of the lever substantially induces the force necessary for the piercing rod to pierce the container.

7. The system of claim 1, further comprising a UV protection member configured and arranged to protect the container from UV radiation prior to piercing of the container.

8. The system of claim 1, further comprising:
a three way valve;
an outlet port in fluid communication with the three way valve and the foam eductor member;
wherein the three way valve is configured such that actuation of the valve to a first state diverts liquid substantially free of aqueous foam to the outlet port and the actuation of the valve to a second state diverts liquid containing aqueous foam to the outlet port;
and wherein the three way valve is actuated to the second state automatically in conjunction with the movement of the piercing rod.

9. The system of claim 1, further comprising a check valve configured and arranged to prevent liquid from flowing into the container.

10. The system of claim 1, further comprising a holding assembly configured and arranged to hold the container in a position in the path of the piercing rod for the piercing rod to pierce the container.

11. A piercing rod assembly, comprising:
a piercing rod configured and arranged to pierce the exterior of a shipping container of aqueous foam and configured and arranged to enable the suction of aqueous foam from the container using the piercing rod without withdraw of the piercing rod from the container; and
an actuation member that is manually actuated to move the piercing rod with sufficient force to pierce the exterior of the container.

12. The piercing rod of claim 11, wherein the actuation member comprises a lever.

13. The piercing rod of claim 12, wherein the force of the actuation of the lever substantially induces the force necessary for the piercing rod to pierce the container.

14. The piercing rod of claim 11, further comprising an orifice near the piercing end of the piercing rod wherein the orifice is configured and arranged to draw aqueous foam.

15. The piercing rod of claim 14, further comprising a channel at least partially contained within the piercing rod and in fluid communication with the orifice and an outlet orifice configured and arranged such that when a vacuum is applied to the outlet orifice, aqueous fluid in contact with the piercing end of the piercing rod will be drawn through the channel.

16. A method of operating a fire suppression system, comprising:
a) actuating an actuation member coupled to a piercing rod wherein the actuation of the actuation member moves the piercing rod with sufficient force to pierce a shipping container for aqueous foam;
b) piercing the exterior of a container with a piercing rod such that the piercing rod contacts aqueous foam contained within the container; and
c) drawing the aqueous foam from the container through the orifice created by the piercing rod.

17. The method of claim 16, wherein the actuation member comprises a lever mechanically coupled to the piercing rod.

18. The method of claim 16, further comprising the step of introducing a container containing aqueous foam into the path of insertion of a piercing rod.

19. The method of claim 16, further comprising the step of combining the aqueous foam with a liquid.

20. The method of claim 19, further comprising the step of applying the liquid and aqueous foam mixture to a fire to suppress the fire.
